(19) United States
(12) Patent Application Publication
(10) Pub. No.: US 2025/0178103 A1
(43) Pub. Date: Jun. 5, 2025

(54) Jaw Set with Modular Platforms and Interchangeable Segments

(71) Applicant: Michael Richard Ramun, Mineral Ridge, OH (US)

(72) Inventor: Michael Richard Ramun, Mineral Ridge, OH (US)

(21) Appl. No.: 18/524,969

(22) Filed: Nov. 30, 2023

(51) Int. Cl. B23D 31/00; B23D 35/00; E02F 3/96

(52) U.S. Cl. CPC B23D 31/008; E02F 3/965; B02C 1/06; B02C 1/10; B02C 21/02; B23D 35/002

(57) ABSTRACT

A tool attachment system for demolition, recycling, and/or material processing applications wherein a platform is part of a jaw of a jaw set. A segment with working surfaces is attached to the platform such that the segment shields the platform from a workpiece. Additionally, the segment may be customized for a particular task thereby providing optimum performance.

### BACKGROUND OF THE INVENTION

### Field of the Invention

The present invention relates to a tool attachment system for demolition, recycling, and/or material processing equipment. More particularly, the present invention relates to interchangeable platforms that are most commonly connected to booms, or arms of excavators, or other machinery and interchangeable segments that may be attached to each platform.

### Background Information

The present application refers to demolition, recycling, and/or material processing equipment. Such a description includes, but is not intended to be restrictive of, the equipment being referenced. Demolition equipment may include heavy duty metal cutting shears, grapples, and concrete processors, which may be mounted on excavators and other machinery, which power hydraulic cylinders for a variety of jobs in the demolition and recycling industries.

In the dismantling of an industrial structure, metal scrap in the form of various diameter pipes, structural I-beams, channels, angles, and sheet metal plates must be efficiently severed and handled by heavy duty metal shears. Metal shears can also be utilized for reducing automobiles, truck frames, and railroad cars. The shears must be able to move and cut the metal scrap into pieces without any significant damage to the shears. In the demolition of industrial structures, concrete crackers are also used to reduce concrete structures into to manageable components, which can then be easily handled and removed from the site. Wood shears and plate shears also represent specialized cutting devices, which are useful, in particular, for demolition or debris removal situations, depending upon the type of material to be cut. Further, a grapple is often utilized where handling of debris or workpieces is a primary function of the equipment. Historically, all of these pieces of equipment represent distinct tools having significant independent capital cost. Consequently, the demolition industry has tended to develop one type of tool associated with each body.

U.S. Pat. No. 7,354,010, hereinafter the '010 patent, is directed to a single jaw set multiple tool attachment system and begins to address this challenge. The '010 patent teaches a single jaw set that accepts multiple inserts such that the jaws may be customized for particular tasks. However, the '010 patent utilizes pivoting jaws and adds a variety of different components directly to these jaws for these different tasks. One jaw configuration may be useable for many tasks and may be optimal for one task. However, the configuration is not optimal for many of the other tasks for which the jaws may be used.

As an example, in FIG. 13 of the '010 patent, the apex 38 is typically used to maximize shear upon a workpiece. However, such a feature hinders the performance of the jaws in other applications for which the jaws may be used.

The Applicant has realized that it is possible to provide a jaw set and include platforms on the jaws of the jaw set with customized segments that may be attached to these platforms to provide a tool that is fully dedicated to a particular function for optimum performance.

### SUMMARY OF THE INVENTION

One embodiment is directed to a first jaw of a jaw set for demolition, recycling, or material processing equipment, wherein the first jaw is configured to be secured with a pivot pin and adapted to allow relative rotation between the first jaw and a second jaw. The first jaw has a platform with a bore extending therethrough about the rotational axis. The platform extends away from the rotational axis to define a first side, a second side opposite to the first side, a first flank, and a second flank opposite to the first flank, wherein the first side and second side are between the first flank and second flank, and a front end is defined by ends of the sides and flanks furthest from the rotational axis.

A segment is secured to the platform, wherein the segment has working surfaces for engaging a workpiece and wherein the segment has a cavity with a shape complimentary to the platform which receives the first flank, the second flank, substantially all of the first side of the platform, and substantially all of the front end of the platform, such that the platform is shielded from substantially all direct engagement with the workpiece.

Another embodiment is directed to a kit for a first jaw with interchangeable segments of a jaw set for demolition, recycling, or material processing equipment, wherein the first jaw is configured to be secured with a pivot pin and adapted to allow relative rotation between the first jaw and the second jaw. The first jaw has a platform with a bore to accept the pivot pin extending therethrough about the rotational axis, wherein the platform extends away from the rotational axis to define a first side, a second side opposite to the first side, a first flank and a second flank opposite to the first flank. The first side and the second side are between the first flank and second flank. A front end is defined by ends of the sides and flanks furthest from the rotational axis. A first segment is secured to the platform, wherein the first segment has working surfaces for engaging a workpiece fully dedicated to a first particular task related to demolition, recycling, or material processing. The first segment has a cavity with a shape complimentary to the platform which receives the first flank, the second flank, the first side of the platform, and the front end of the platform, such that the platform is shielded from substantially all direct engagement with the workpiece. A second segment is adapted to be secured to the platform, wherein the second segment has working surfaces for engaging a workpiece fully dedicated to a second particular task related to demolition, recycling, or material processing, wherein the first task and the second task are different. The second segment has a cavity which receives the first flank, the second flank, the first side of the platform, and the front end of the platform, such that the platform is shielded from substantially all direct engagement with the workpiece.

Yet another embodiment of the invention is directed to a jaw set for demolition, recycling, or material processing equipment. The jaw set has a first jaw and a second jaw. The first jaw is secured with a pivot pin and adapted to allow relative rotation between the first jaw and the second jaw. Each jaw has a platform with a bore to accept the pivot pin extending therethrough about the rotational axis, wherein the platform extends away from the rotational axis. Each jaw also has a segment secured to the platform, wherein the segment has working surfaces for engaging a workpiece. The segment has a cavity with a shape complimentary to the platform which covers a substantial portion of the platform, such that the platform is shielded from substantially all direct engagement with the workpiece.

Yet another embodiment of the invention is directed to a method for securing a platform onto a first jaw set, comprising the steps of a) positioning the segment in a stationary position with the cavity exposed, b) moving the platform into the cavity so that the platform first bore aligns with the segment first bore, c) securing the first locking pin into the platform first bore and the segment first bore, d) pivoting the segment about the first locking pin until a second bore of the segment aligns with a second bore of the platform; and e) inserting and securing therein a second locking pin into the second bore of the segment and a second bore of the platform.

### BRIEF DESCRIPTION OF THE DRAWINGS

FIG. 1 is a hydraulic machine with a concrete cracker attached to the end of a boom;

FIGS. 2A and 2B illustrate the concrete cracker of FIG. 1 in the open position;

FIG. 2C is the concrete cracker illustrated in FIGS. 2A and 2B in the closed position;

FIG. 3 is an exploded view of two jaws with platforms thereupon;

FIG. 4 is a view of a segment inverted to illustrate the compatible surfaces with a platform;

FIG. 5 is a view of the segment secured to the platform;

FIGS. 6A through 6D illustrate various views of the segment/platform configuration of FIG. 5;

FIG. 7 illustrates a perspective exploded view of a jaw set with platforms in accordance with the subject invention;

FIG. 8 illustrates an exploded end view of the jaw set of FIG. 7;

FIG. 9 is a view showing the jaw set of FIG. 7 assembled;

FIG. 10 is an end view of the jaw set of FIG. 7;

FIG. 11 is a cutaway view of the jaw set along line “11-11” in FIG. 7;

FIG. 12 is an end view similar to that of FIG. 10, but with the receivers removed for clarity;

FIGS. 13 through 17 illustrates the steps to attach a segment to a platform;

FIGS. 18A and 18B illustrate what will be defined as two 90° platforms;

FIGS. 19A and 19B illustrate what will be defined as two 45° platforms;

FIGS. 20A and 20B illustrate a combination of one 90° platform and one 45° platform;

FIGS. 21A and 21B represent a combination of one 45° platform and one 90° platform;

FIGS. 22A-22C illustrate a concrete cracker in accordance with one embodiment of the subject invention;

FIGS. 23A-23C illustrate a concrete crusher in accordance with one embodiment of the subject invention;

FIGS. 24A-24C illustrate a cast breaker in accordance with one embodiment of the subject invention;

FIGS. 25A-25C illustrate a rail breaker in accordance with one embodiment of the subject invention;

FIGS. 26A-26C illustrate a sorting tine in accordance with one embodiment of the subject invention;

FIGS. 27A-27C illustrate a grapple tine in accordance with one embodiment of the subject invention;

FIGS. 28A-28C illustrate segment bases for fabrication in accordance with one embodiment of the subject invention;

FIGS. 29A-29C illustrate segment bases for fabrication coupled with one embodiment of a bucket;

FIGS. 30A-30C illustrate segment bases for fabrication coupled with one embodiment of a grab;

FIGS. 31A-31C illustrate a tree shear in accordance with one embodiment of the subject invention;

FIGS. 32A-32C illustrate dedicated platforms and in this instance, a heavy melt shear knife coupled with a heavy melt dedicated shear anvil in accordance with one embodiment of the subject invention;

FIGS. 33A-33C illustrate a slab processor in accordance with one embodiment of the subject invention;

FIG. 34 illustrates a hydraulic machine wherein a cylinder activates a link associated with each jaw such that each jaw moves; and

FIG. 35 illustrates a hydraulic cylinder wherein one set of jaws is fixed while the hydraulic cylinder moves only the other jaw.

### DESCRIPTION OF THE PREFERRED EMBODIMENTS

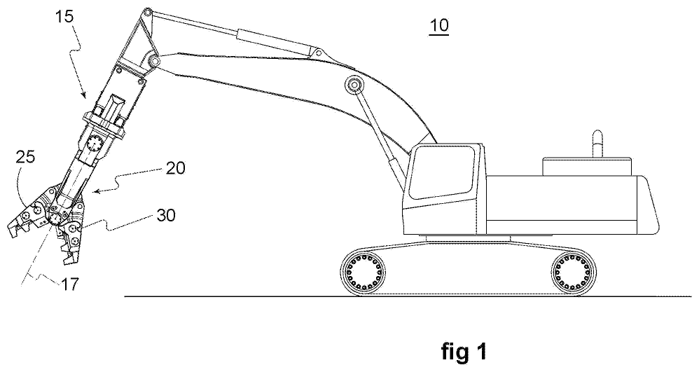

FIG. 1 illustrates an excavator 10 fitted with a boom 15. At the free end of the boom 15 is a jaw set 20 comprised of a first jaw 25 and a second jaw 30.

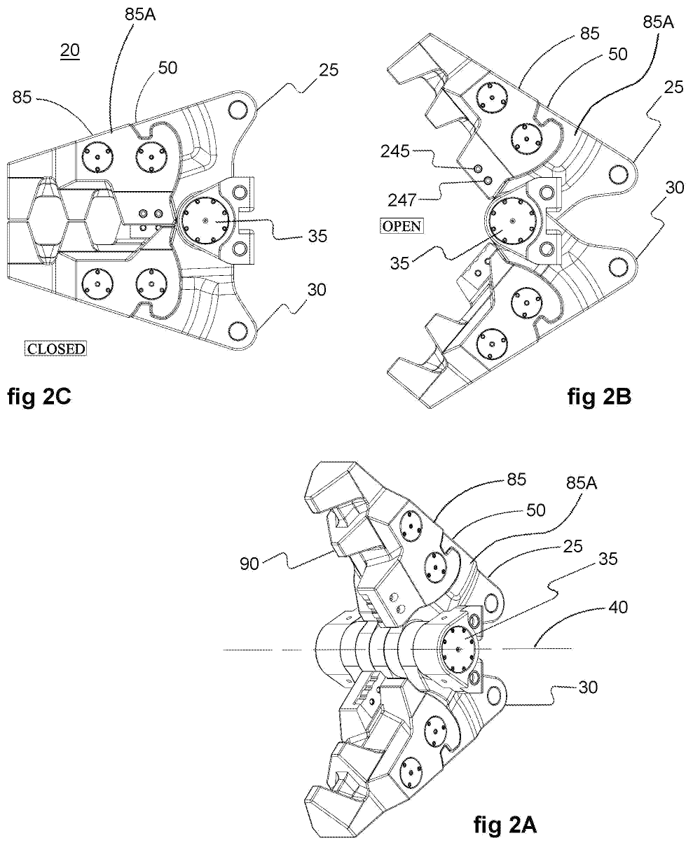

FIGS. 2A and 2B illustrate the jaw set 20 in FIG. 1 in a perspective view and a side view, while FIG. 2C illustrates the same jaw set 20 in a side view but in a closed position. The first jaw 25 is configured to be secured with a pivot pin 35 to the opposing second jaw 30 about a rotational axis 40. While what is described herein is an embodiment where the first jaw 25 and the second jaw 30 are secured by a common pivot pin 35, it is also possible for the first jaw 25 to rotate and for the second jaw 30 to be fixed. Furthermore, it is possible to space the first jaw 25 from the second jaw 30 so that each has their own pivot pin and furthermore to fix the second jaw 30 so that only the first jaw 25 rotates. In each of these arrangements, the first jaw 25 is secured to a pivot pin and adapted to allow relative rotation between the first jaw 25 and the second jaw 30.

The jaw set 20 illustrated in FIGS. 1 and 2A-2C is a concrete cracker 85A. However, as will be discussed, the subject invention allows for modification of the jaw set 20 to accommodate other demolition, recycling, and material processing equipment.

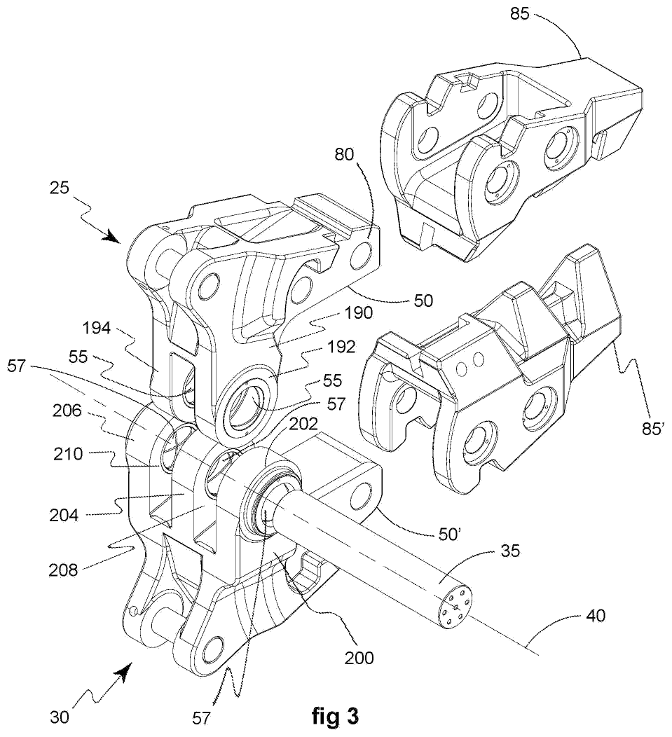

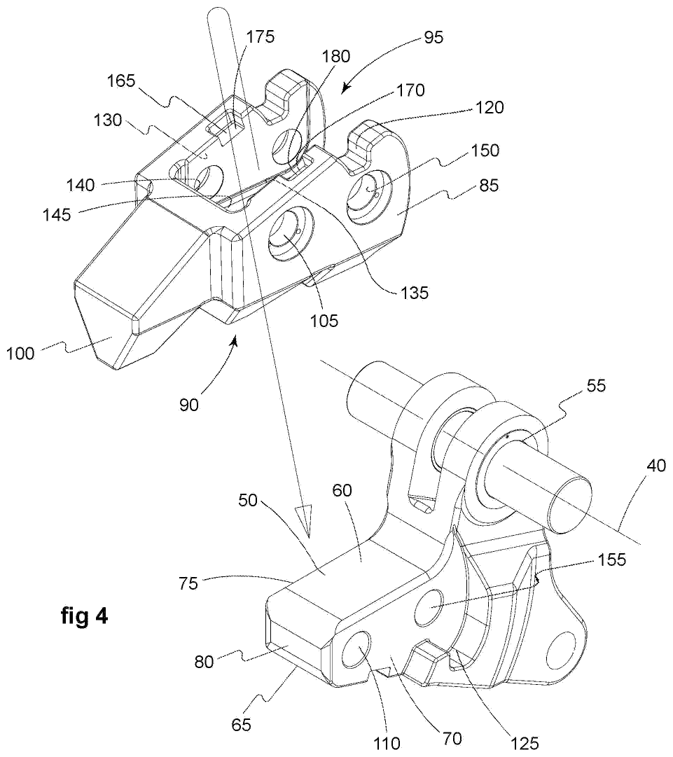

Directing attention to FIGS. 3 and 4, the first jaw 25 with the platform 50 has a bore 55 extending therethrough about the rotational axis 40. The platform 50 of the first jaw 25 extends away from a rotational axis 40 to define a first side 60, a second side 65, a first flank 70, and a second flank 75 opposite to the first flank 70. The first side 60 and the second side 65 are between the first flank 70 and the second flank 75. A front end 80 is defined by the intersection of the ends of the first side 60 and second side 65 and the first flank 70 and the second flank 75 furthest from the rotational axis 40.

As illustrated in FIGS. 2A-2C, a segment 85 is secured to the platform 50 of the first jaw 25 and essentially protects the platform 50 and the remainder of the first jaw 25 from exposure to a workpiece upon which the jaw set 20 acts. As a result, the platform 50 and the remainder of the first jaw 25 covered by the segment 85 do not experience the wear and potential damage that may be inflicted by a workpiece. For the life of the jaw set 20, only the segment 85 must be replaced as the result of direct contact with the workpiece.

FIG. 3 illustrates the pivot pin 35 aligned with the bore 55 of the first jaw 25 and the bore 57 of the second jaw 30 extending through the first jaw 25 and the second jaw 30. As illustrated in FIG. 3, the pivot pin 35 pivotally secures the first jaw 25 to the second jaw 30. It should be noted that the pivot pin 35 uses a slip fit within the bores 55, 57 to make removal possible.

Directing attention to FIG. 4, the segment 85 has a working surface 90 for engaging a workpiece. The segment 85 has a cavity 95 with a shape complementary to the platform 50 of the first jaw 25. The segment 85 is received by the first flank 70 of the platform 50, the second flank 75 of the platform 50, substantially all of the first side 60 of the platform 50, and substantially all of the front end 80 of the platform 50 such that the platform 50 is shielded from substantially all direct engagement with the workpiece.

Furthermore, as can be seen in FIG. 4, the working surface 90 of the segment 85 may have a front end 100 that protrudes beyond the front end 80 of the platform 50.

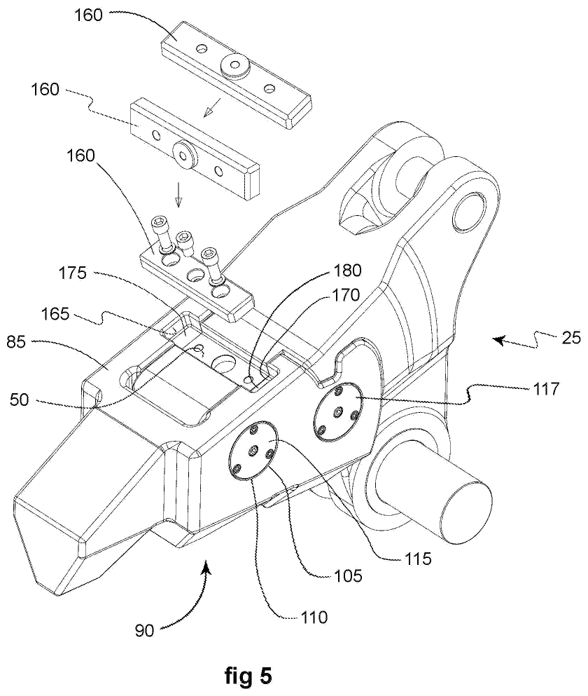

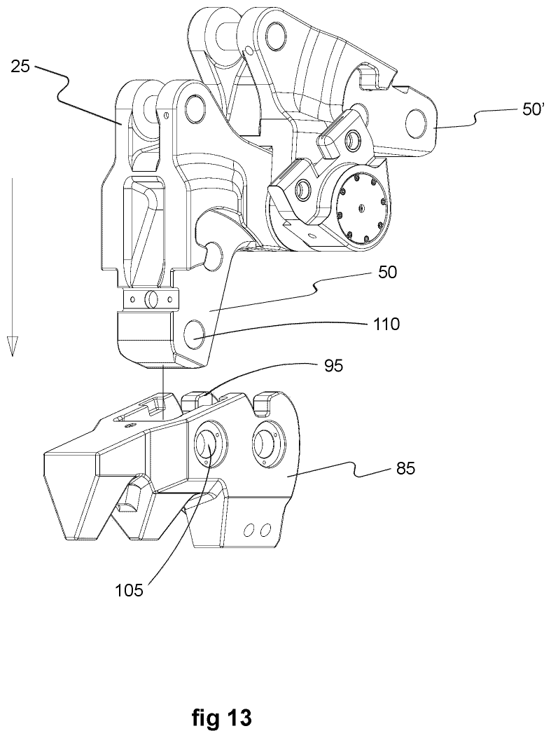

As further illustrated in FIG. 4 and FIG. 5 and in FIGS. 13-17, the segment 85 has a segment first bore 105 and the platform 50 of first jaw 25 has a platform first bore 110. With the segment 85 and the platform 50 mated, as illustrated, for example, in FIG. 5, the segment first bore 105 is coaxial with the platform first bore 110 to accept a first locking pin 115. The segment 85 pivots about the first locking pin 115 to engage with the platform 50. Furthermore, the platform 50 and the segment 85 are secured to one another when the segment 85 engages with the platform 50 as illustrated in FIG. 4 and the first locking pin 115 and a second locking pin 117 are secured within the segment bores 105, 150 and the platform bores 110, 155.

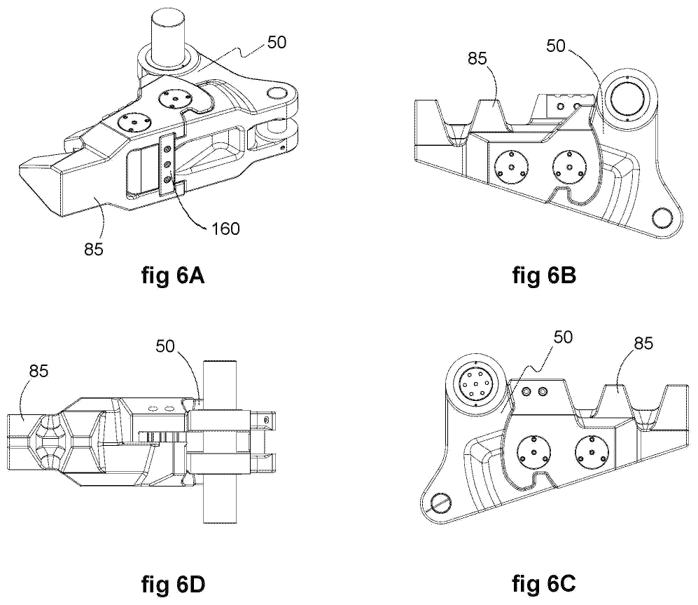

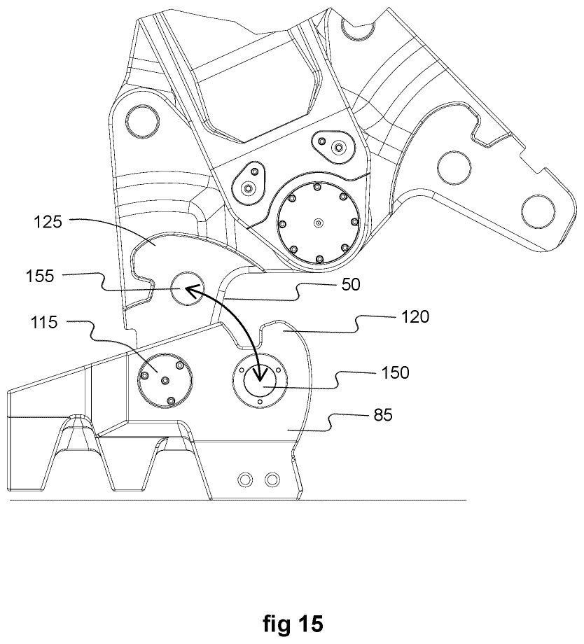

As further illustrated in FIG. 4, the segment 85 has a hook portion 120 and the platform 50 of the first jaw 25 has a complementary hook portion 125. When the segment 85 pivots about the first locking pin 115 within the first bore 105 of the segment 85 and the first bore 110 of the platform 50, the hook portions 120, 125 are engaged with one another (See also FIG. 15). FIGS. 6A-6D show additional views of the arrangement in FIG. 5 but with an alignment bar 160 secured.

FIG. 4 illustrates the segment 85 in an inverted position to reveal the cavity 95, which fits over the platform 50 of first jaw 25. The cavity 95 of the segment 85 has a first wall 130 and an opposing second wall 135. The cavity 95 of the segment 85 also has a front wall 140 and an inner wall 145 therebetween connecting the first wall 130 to the second wall 135.

Directing attention to FIG. 4 and FIG. 5 and FIGS. 13-17, the first bore 110 of the platform 50 of first jaw 25 aligns with the first bore 105 of the segment 85 and a first locking pin 115 is inserted therein. Furthermore, the segment 85 has a second bore 150 and the platform 50 has a second bore 155 which accepts a second locking pin 117 so that the segment 85 may be secured to the platform 50.

With the segment 85 secured to the platform 50 with the pins 115, 117 extending through the bores 150, 155, an alignment bar 160 may be used secured to the platform 50 to not only more closely align the segment 85 with the platform 50, but furthermore, the alignment bar 160 provides an additional level of integrity for the connection of the segment 85 to the platform 50.

In particular, directing attention to FIGS. 4 and 5, the first wall 130 of the segment 85 has a recess 165 and the second wall 135 of the segment 85 has an opposing recess 170. The alignment bar 160 is secured to the platform 50 and engages the recesses 165, 170 to limit the motion between the platform 50 and the segment 85.

FIG. 5 illustrates that the recess 165 of segment 85 has a floor 175, while the recess 170 has a floor 180, such that the alignment bar 160 secured to the platform 50 abuts against the floor 175 of recess 165 and against the floor 180 of recess 170 to secure the segment 85 against the platform 50.

This feature is particularly advantageous when separating the segment 85 from the platform 50 of the first jaw 25 because the alignment bar 160 retains the segment 85 to the platform 50 when the first locking pin 115 and the second locking pin 117 are removed.

Additionally, the tolerances for the engagement of the alignment bar 160 between platform 50 of the first jaw 25 and the segment 85 are less than those between the platform 50 and the segment 85 secured only with pins through the bores 105, 110 and 150, 155. As a result, the alignment bar 160 provides tighter tolerances to secure and align the segment 85 relative to the platform 50.

Returning to FIGS. 3 and 4, it is apparent that the segment 85 secured to the platform 50 receives and engages substantially all of the first side 60 of the platform 50, and substantially all of the front end 80 of the platform 50 along with the first flank 70 and the second flank 75 such that the platform 50 is shielded from substantially all direct engagement with a workpiece.

This provides a significant benefit to the prior art designs which do not completely protect the jaw from the workpiece. As a result, in the prior art designs, the workpieces are engaged not only by surfaces designed and intended to engage the workpiece, but furthermore the workpiece is engaged by other portions of the jaw that are unprotected and not intended to engage a workpiece. As a result, over time the jaw itself becomes worn and damaged, and must be reconditioned or replaced.

In accordance with the subject invention, the platform 50 is substantially protected by the segment 85 from the workpiece such that even after extensive operations, the platform 50 and the first jaw 25 associated with the platform 50 is exposed to minimum wear from the workpiece.

By doing so, wear is concentrated on the segment 85 such that the platform 50 and first jaw 25 are protected. As a result, the platform 50 and first jaw 25 have a much greater life expectancy than the prior designs where the equivalent of the platform or the jaw was exposed to the workpiece.

The platform 50 so far discussed, best illustrated in FIG. 3, is associated with the first jaw 25. Directing attention to FIG. 3, the second jaw 30 is essentially identical to first jaw 25 with the exception of the connection to the pivot pin 35.

The first jaw 25 has a base 190 with two legs 192, 194 spaced from one another. Each leg has a bore 55 extending therethrough such that the bore 55 is co-axial. The second jaw 30 has a base 200 with three legs 202, 204, 206 spaced from one another, each with a bore 57 extending therethrough such that the bore is co-axial. The legs 192, 194 of the first jaw 25 are positioned within slots 208, 210 between the legs 202, 204, 206 of the second jaw 30 such that the bore 50 and the bore 57 are aligned along a common rotational axis 40. Thereafter, the pivot pin 35 is secured within the bores 55, 57 to assemble the jaw set 20.

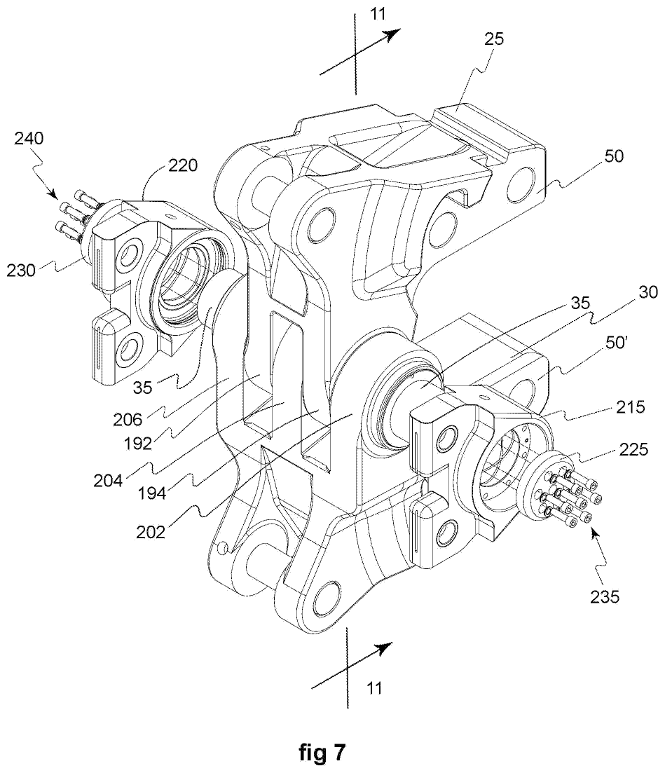

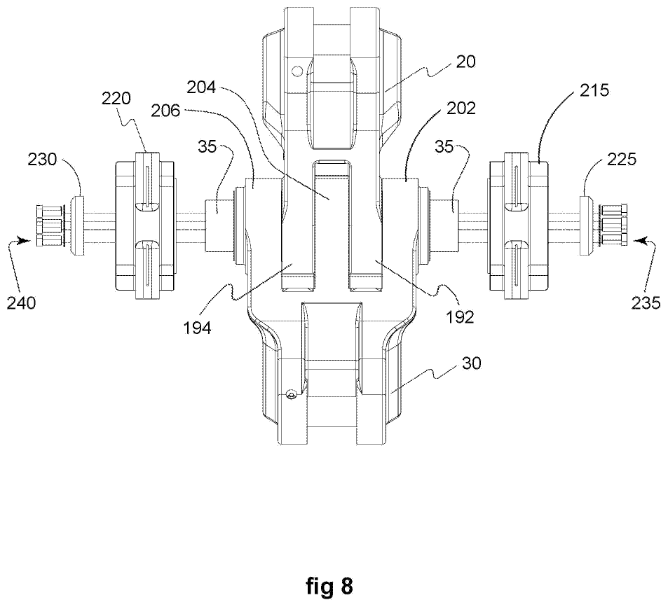

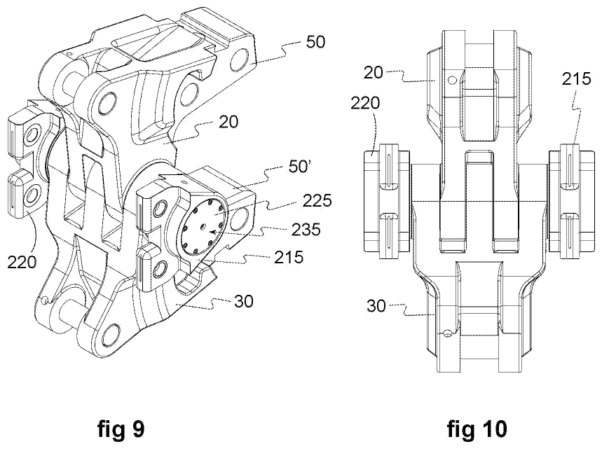

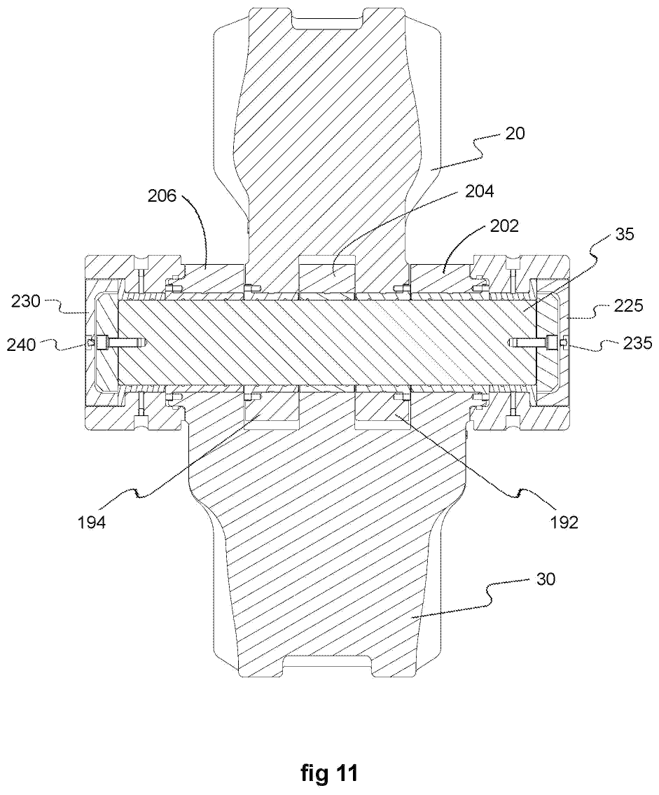

FIGS. 7-12 show additional features of the jaw set 20 assembly. As illustrated in FIG. 7, once the pivot pin 35 is inserted within the bores 55, 57 (not shown) of the legs 192, 194 of the first jaw 25 and legs 202, 204, 206 of the second jaw 30, then receivers 215, 220 are placed over each end of the pivot pin 35. The receivers 215, 220 are then each secured to the pivot pin 35 by plates 225, 230 and secured to the pivot pin with bolts 235, 240.

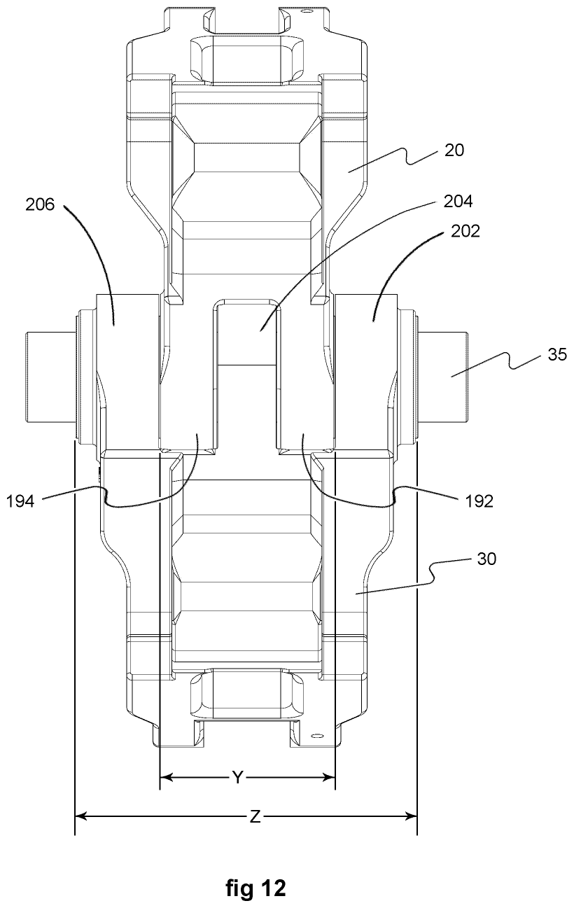

The jaw set 20 in accordance with FIGS. 7-12 provides greater structural integrity than those jaw sets with only a pair of legs extending from one jaw engaging with a single jaw from another jaw. In particular, directing attention to FIG. 12, for optimum support, the distance Y between the outer edges of the two legs 192, 194 of the first jaw 25 is at least ½ the distance Z between the outer edges of the two legs 202, 206 of the second jaw 30. Such an arrangement minimizes the deformation of the jaws 25, 30 under a torque loading.

Directing attention to FIGS. 2A-2C, the segment 85 associated with the first jaw 25 includes a blade 245 that is independently secured to the remainder of the segment 85 through bolts 247.

While the segment 85 may have more than one part, it is also possible for the segment 85 to have a unitary construction, whereby the entire working surface 90 is unitary and no additional attachments are provided. In particular, the segment 85 may be a single part.

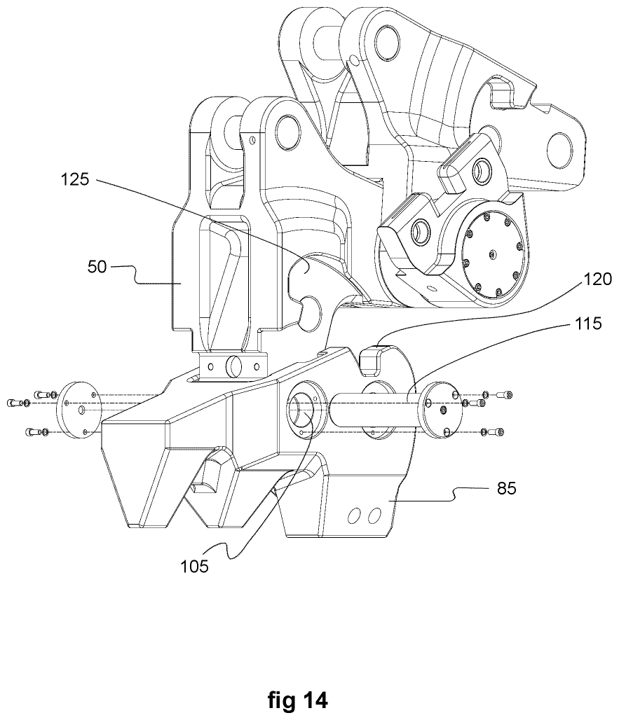

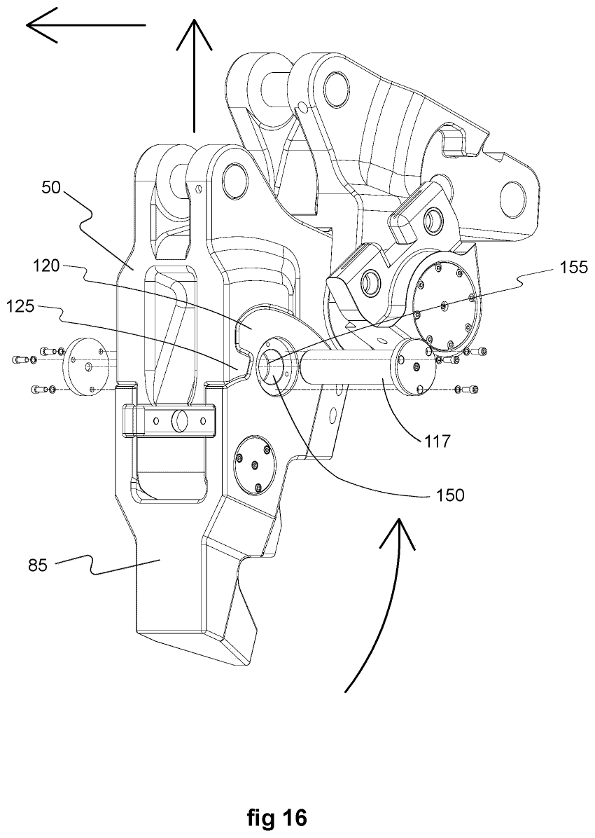

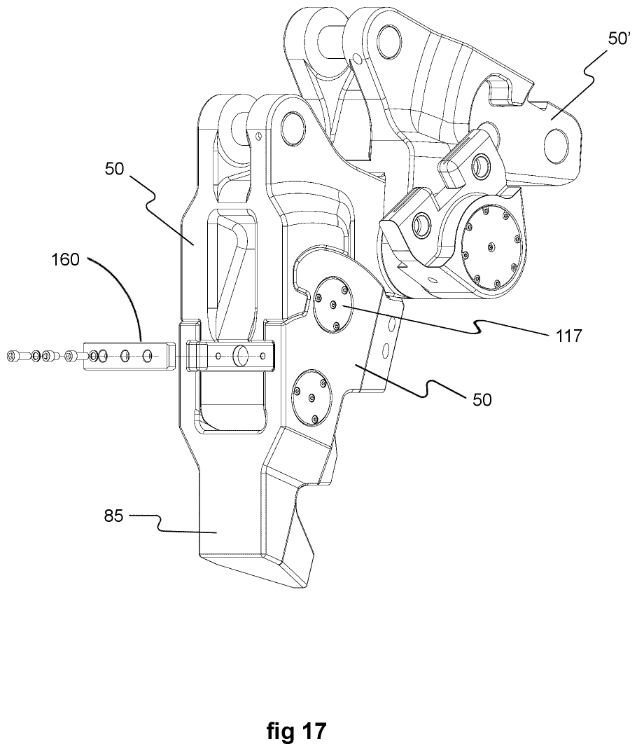

FIGS. 13-17 illustrate a method for securing a segment 85 onto a platform 50 of the first jaw 25 using the jaw set 20 illustrated in FIGS. 2A-2C. In particular, as illustrated in FIG. 13, the segment 85 is positioned in a stationary position with a cavity 95 exposed. The platform 50 is placed over the segment 85 and the platform 50 is moved into the cavity 95, so that the first bore 110 of the platform 50 aligns with the first bore 105 of the segment 85. Thereafter, as illustrated in FIG. 14, a first locking pin 115 is secured into the first bore 105 of the segment 85 and the first bore 110 of the platform 50 (FIG. 13). As further illustrated in FIG. 15, the platform 50 is then pivoted about the first locking pin 115 until the second bore 155 of the platform 50 aligns with the second bore 150 of the segment 85. As illustrated in FIG. 16, a second locking pin 117 is inserted and secured within the second bore 150 of the segment 85 and the second bore 155 of the platform 50. Note that the hook portions 120, 125 engage with one another. Thereafter, as illustrated in FIG. 17, the second locking pin 117 is secured to complete assembly of the segment 85 to the platform 50. To minimize tolerance between the platform 50 and the segment 85, an alignment bar 160 may be secured to the segment 85 and to the platform 50.

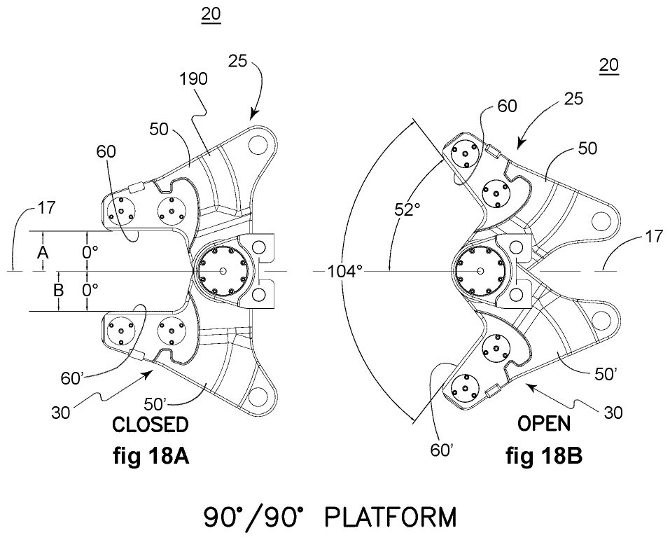

For convenience, when the second jaw 30 is discussed and an element of the second jaw 30 is similar to one of the first jaw 25, that element will be referred to with an “′”, such as platform 50 associated with the first jaw 25 and platform 50′ associated with jaw 30. The jaws 25, 30 may be fabricated for different configurations. Generally stated, and with respect to the jaw set 20 found in FIG. 18A, in the fully closed position of the jaw set 20, the first sides 60, 60′ of the platforms 50, 50′ of each jaw 25, 30 form an angle of 0° with one another. As illustrated in FIG. 18B, the jaws 25, 30 may be open to form an angle of 104° with one another. For identification, the platforms in FIGS. 18A and 18B will be described as 90 degree platforms. For reference, a neutral axis 17 of the boom 15 of FIG. 1 is included.

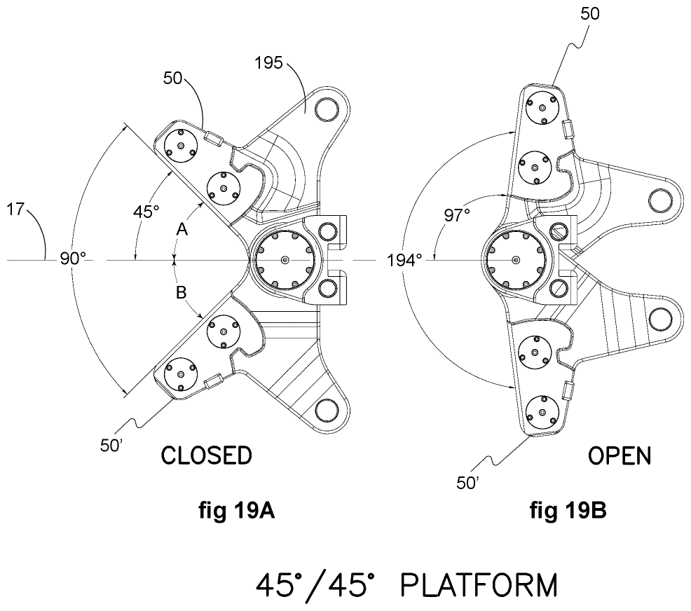

With respect to the jaw set 20 found in FIGS. 19A and 19B, from the fully opened position (FIG. 19B) to the fully closed position (FIG. 19A), there is a range of) 104° (194°−90°. For identification, the platforms 50, 50′ herein will be described as 45 degree platforms. From another perspective in the closed position, each of the platforms 50, 50′ form an angle A, B respectively of 45° with respect to the neutral axis 17.

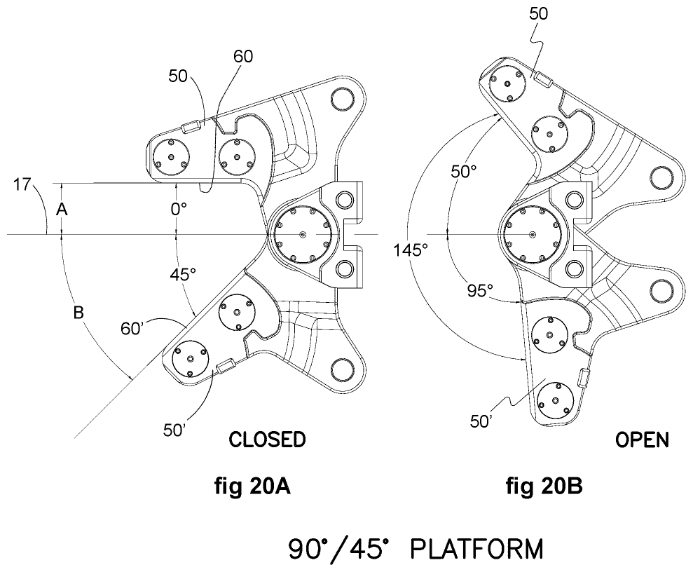

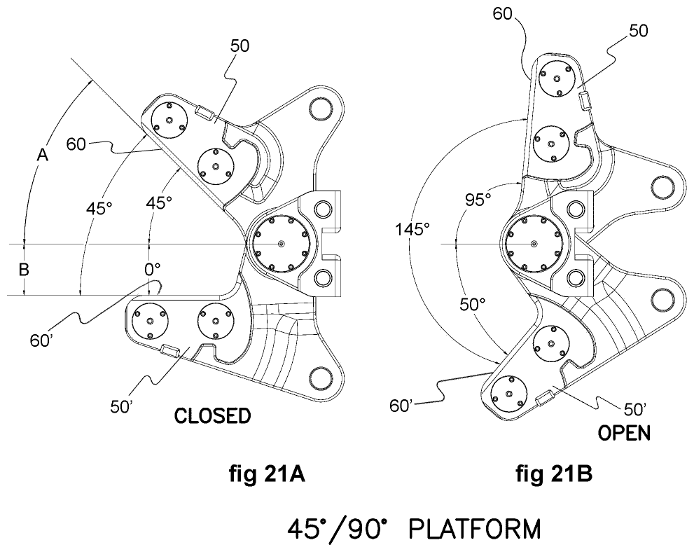

FIGS. 20A and 20B illustrate a jaw set 20 with a combination of a 90° platform 50 and a 45π platform 50′. As shown, the range of openings of the platform first sides 60, 60′ of the platforms 50, 50′ is 45 in the closed position and 145° in the open position. From another perspective, each platform 50, 50′ forms an angle A, B respectively of 45° with respect to the neutral axis 17. FIGS. 21A and 21B show an arrangement similar to 20A and 20B but with the platforms 50, 50′ reversed.

What has been described so far are platforms 50, 50′ with a segment 85 for use as a concrete cracker 85A. In particular, such a platform as part of a jaw set 20 is illustrated mounted to a boom 15 as shown in FIG. 1. FIG. 1 illustrates a jaw set 20 attached to the boom 15 of an excavator 10. For reference, a neutral axis 17 extends through the center of the boom 15 and through the coaxial bores 55, 57 of each of the first jaw 25 and the second jaw 30. Returning to FIGS. 18A and 18B, the first side 60 of platform 50 forms a first angle A with the neutral axis 17 and the first side 60. The first side 60′ of the other platform 50′ forms a second angle B with the neutral axis 17. The angles A and B are equal in FIGS. 18A and 18B. However, the platforms 50, 50′ may be different such that the first angle A and the second angle B form different angles as illustrated in FIGS. 20A and 20B and in FIGS. 21A and 21C.

While the segments 85 discussed so far with respect to FIGS. 2A-2C have been directed to a concrete crusher 85A, it should be appreciated that a major advantage of the subject invention is that the segment 85 may be fabricated to achieve any number of a variety of uses for demolition, recycling, or material processing equipment. For example, the following FIGS. illustrate a platforms 50, 50′ similar to that discussed so far, but with a number of different segments 85 for different operations.

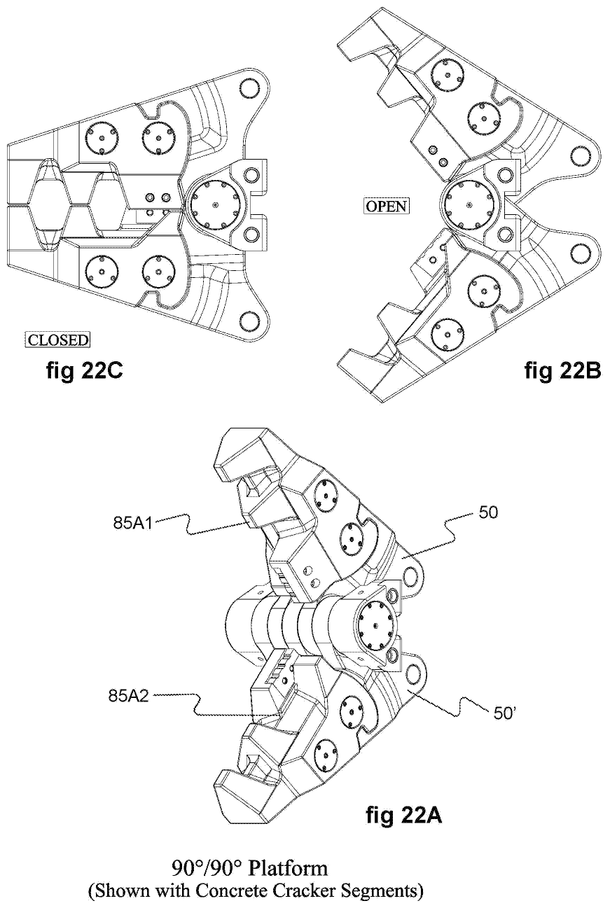

FIGS. 22A-22C illustrate platforms 50, 50′ with a segments 85A1 and 85A2 for use with a concrete cracker.

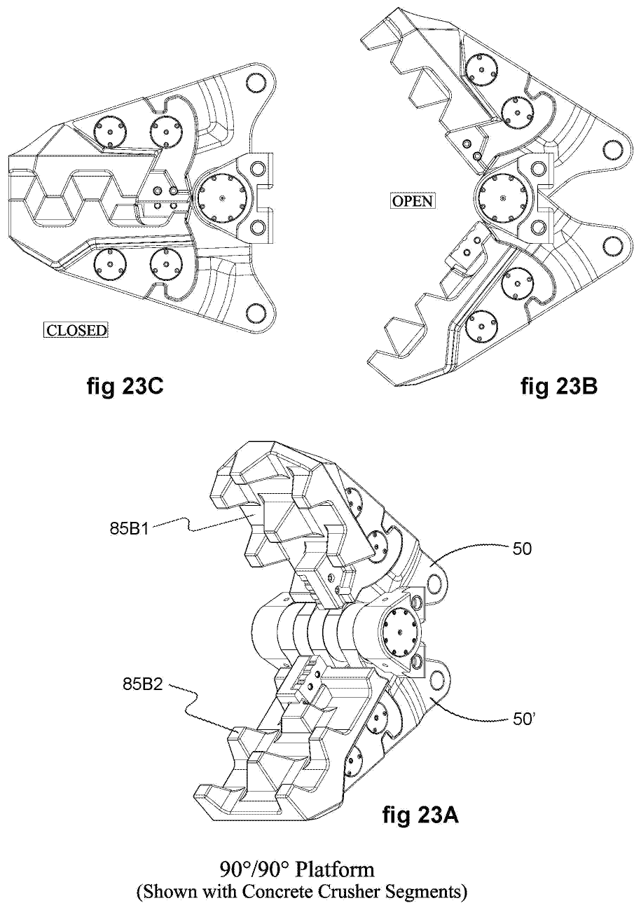

FIGS. 23A-23C illustrate platforms 50, 50′ with segments 85B1 and 85B2 directed to concrete crushing.

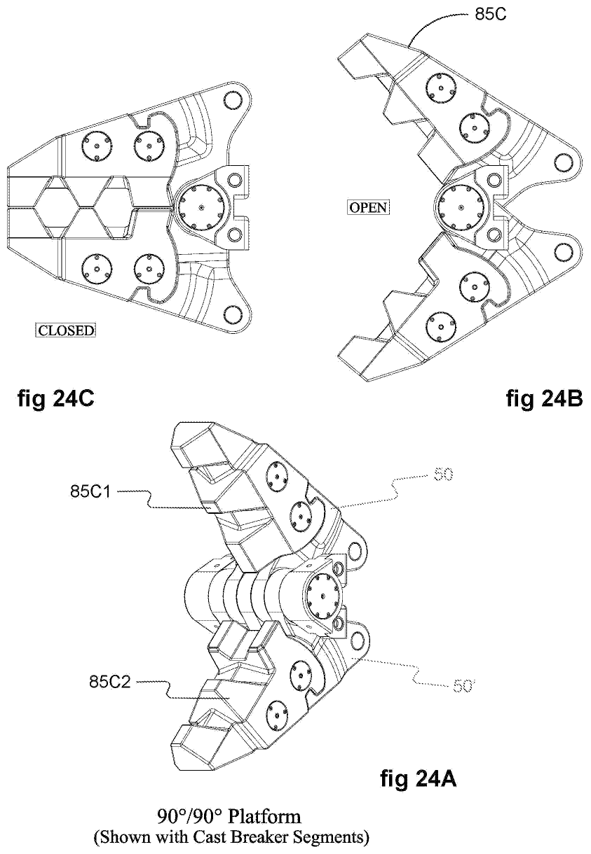

FIGS. 24A-24C illustrate platforms 50, 50′ with segments 85C1 and 85C2 directed for cast breaking.

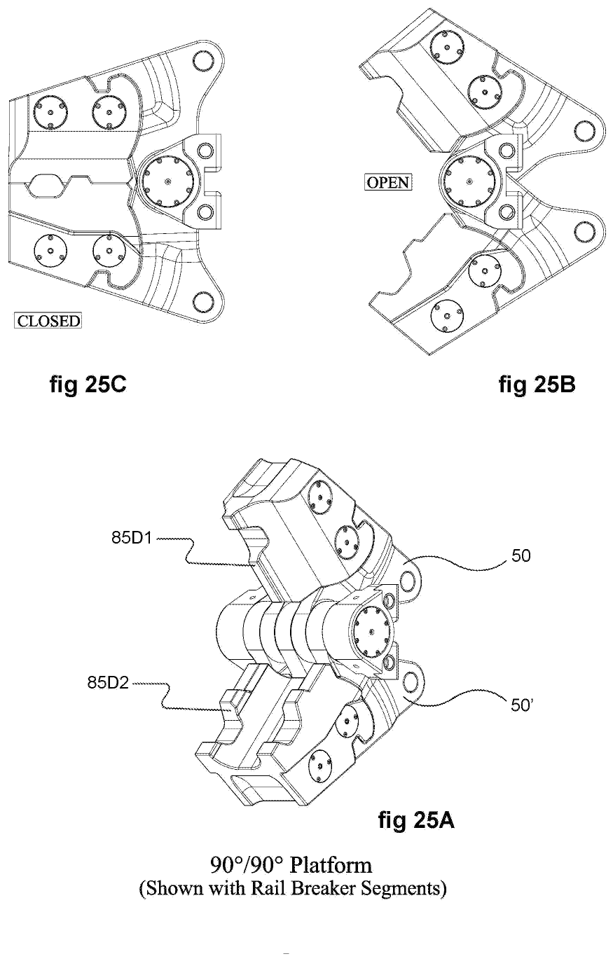

FIGS. 25A-25C illustrate platforms 50, 50′ with segments 85D1 and 85D2 directed to rail breaking.

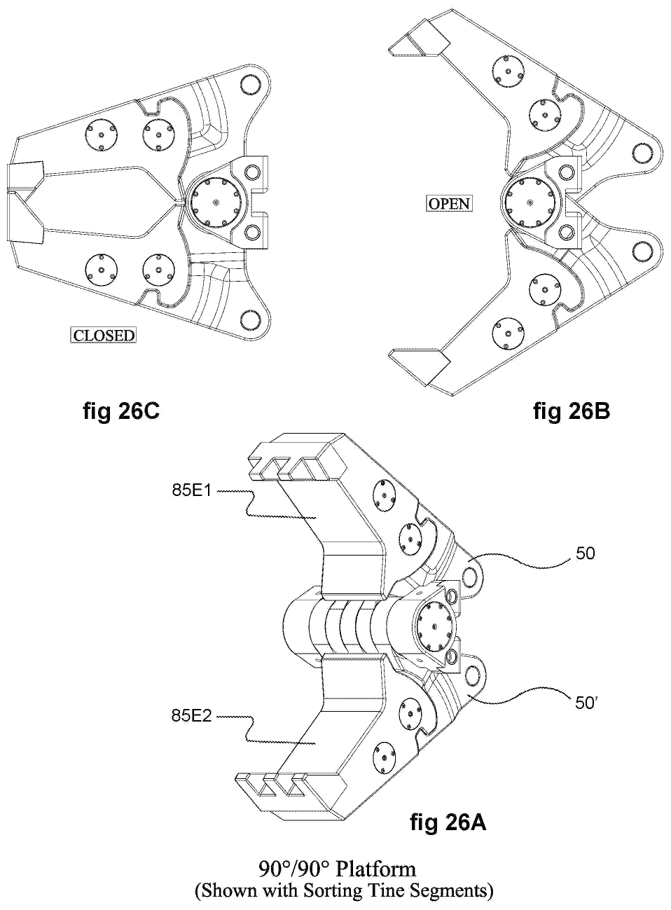

FIGS. 26A-26C illustrate platforms 50, 50′ with segments 85E1 and 85E2 acting as a sorting time.

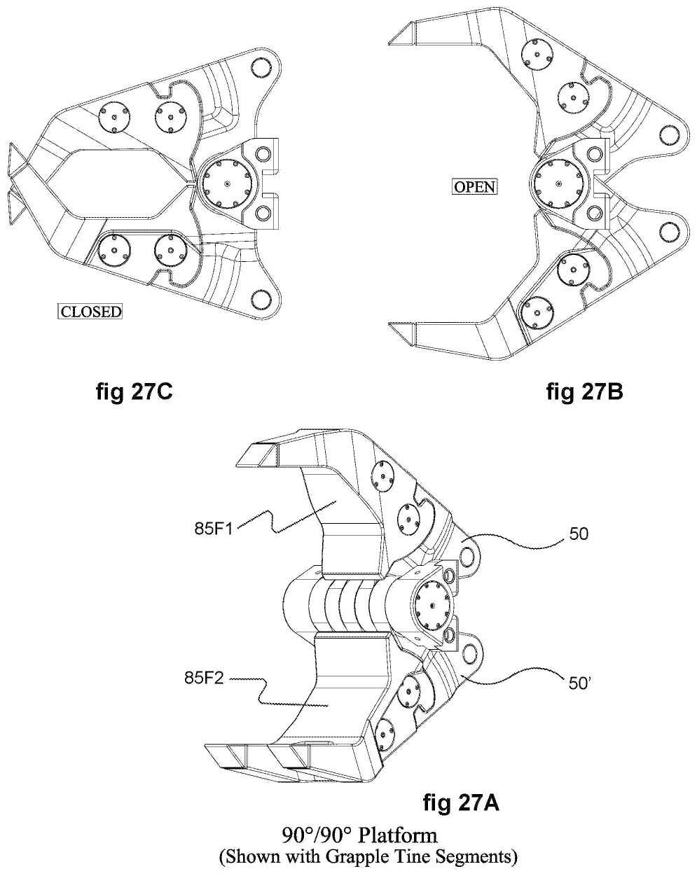

FIGS. 27A-27C illustrate platforms 50, 50′ with segments 85F1 and 85F2 directed to a grapple tine.

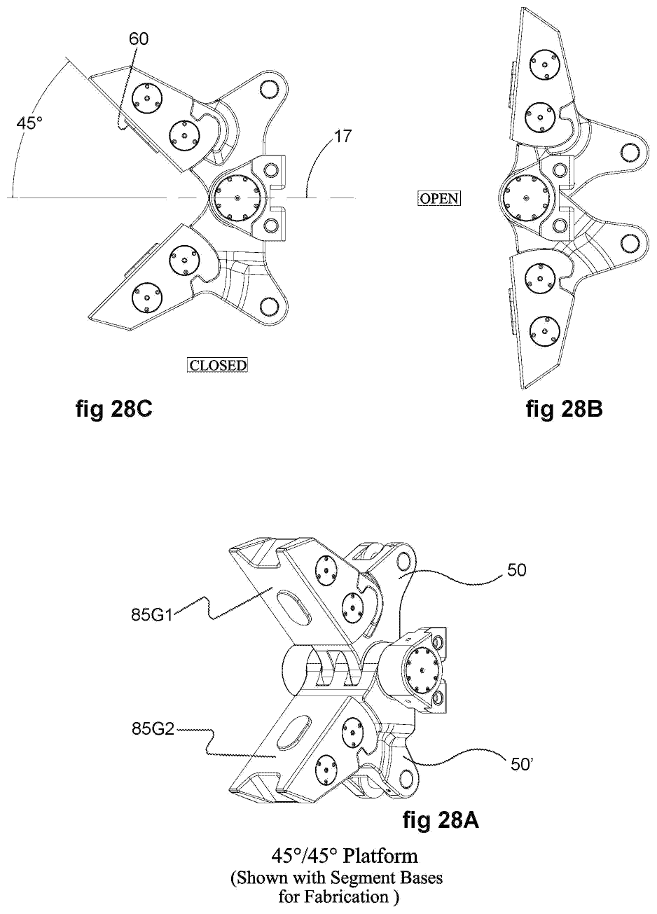

FIGS. 28A-28C illustrate platforms 50, 50′ with segments 85G1 and 85G2 which act as bases upon which to mount customized tools.

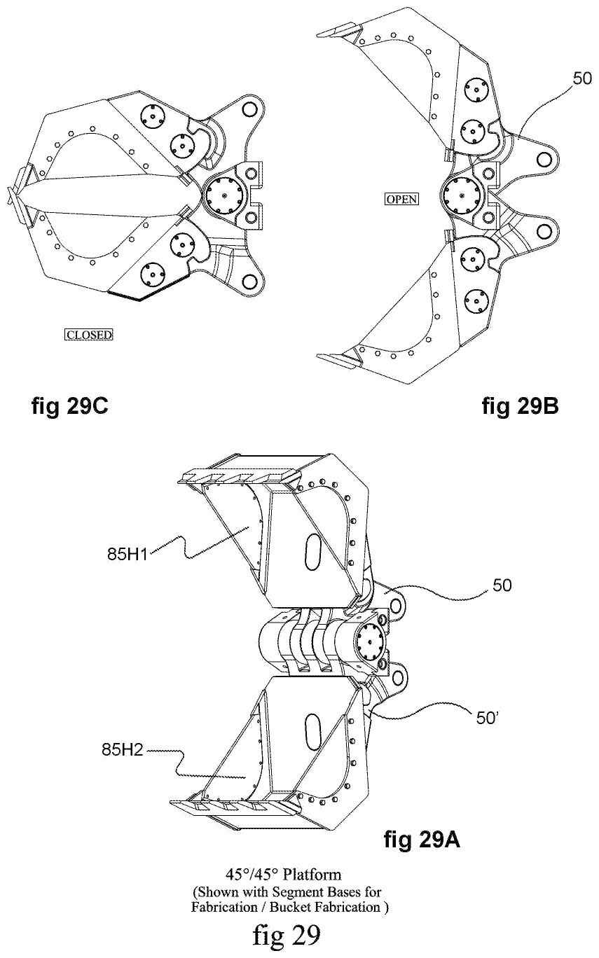

FIGS. 29A-29C illustrate a platform 50, 50′ with segments 85H1 and 85H2 to make up a bucket.

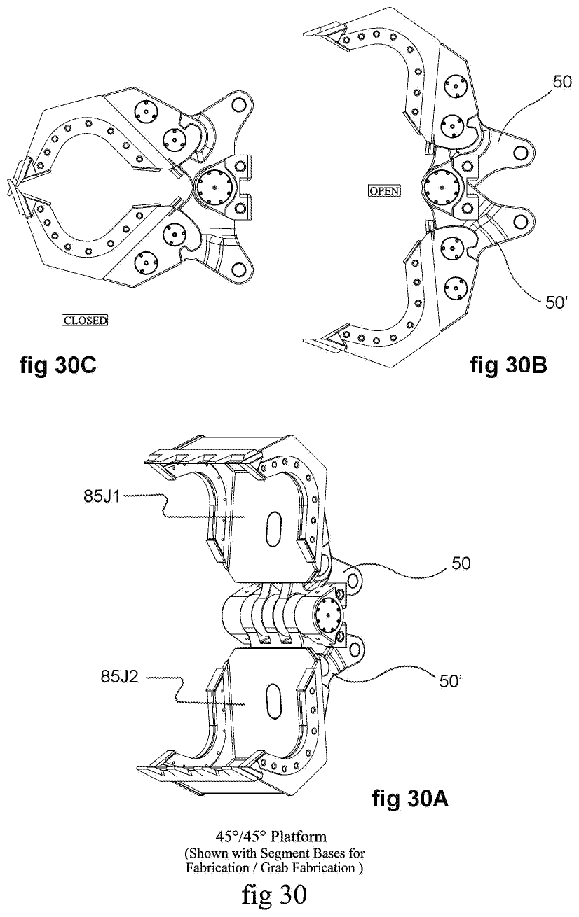

FIGS. 30A-30C illustrate platforms 50, 50′ with segments 85J1 and 85J2 for a grab.

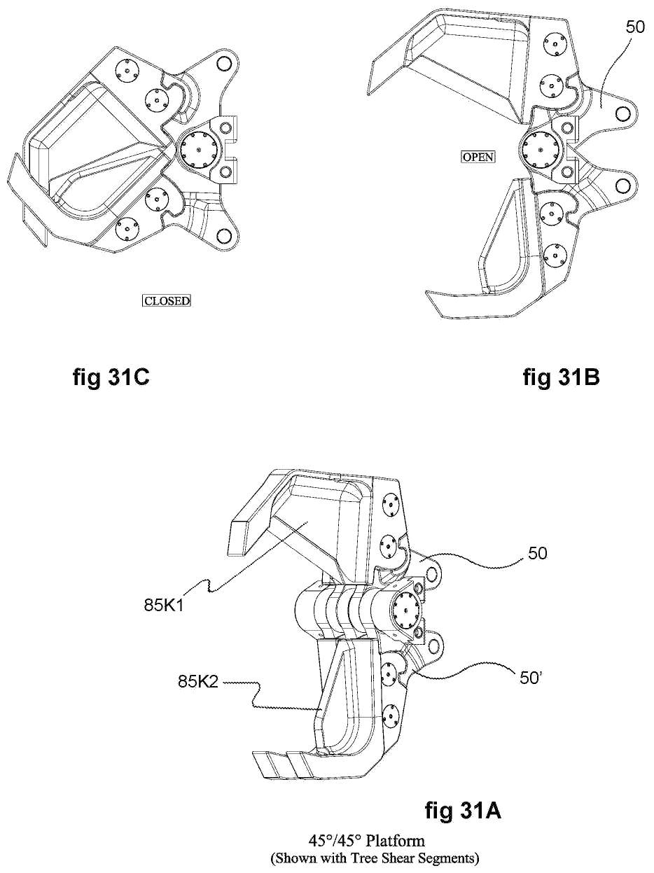

FIGS. 31A-31C illustrate platforms 50, 50′ with segments 85K1 and 85K2 for use as a tree shear.

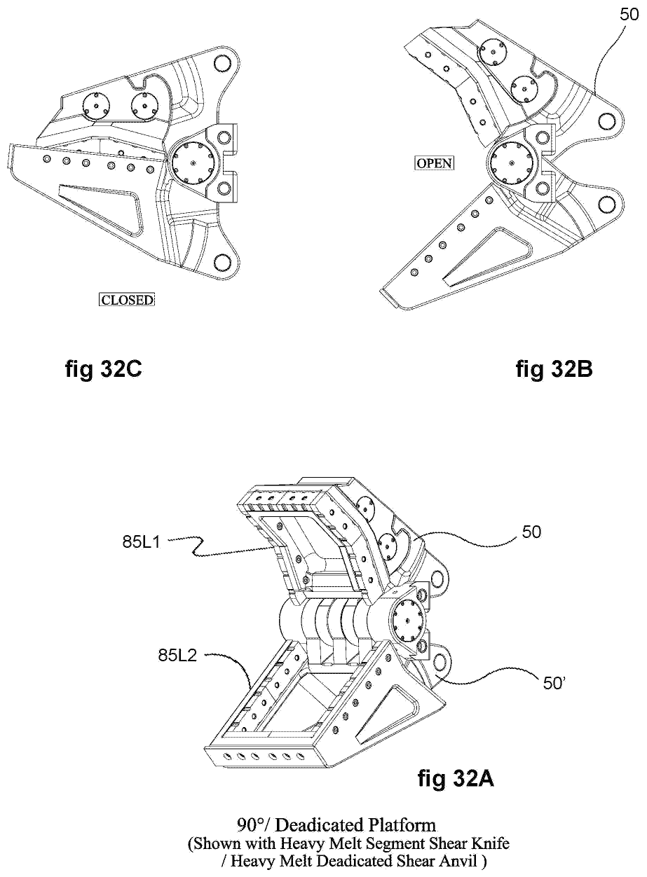

FIGS. 32A-32C illustrate platforms 50, 50′ having segments 85L1 and 85L2 directed to a heavy melt shear.

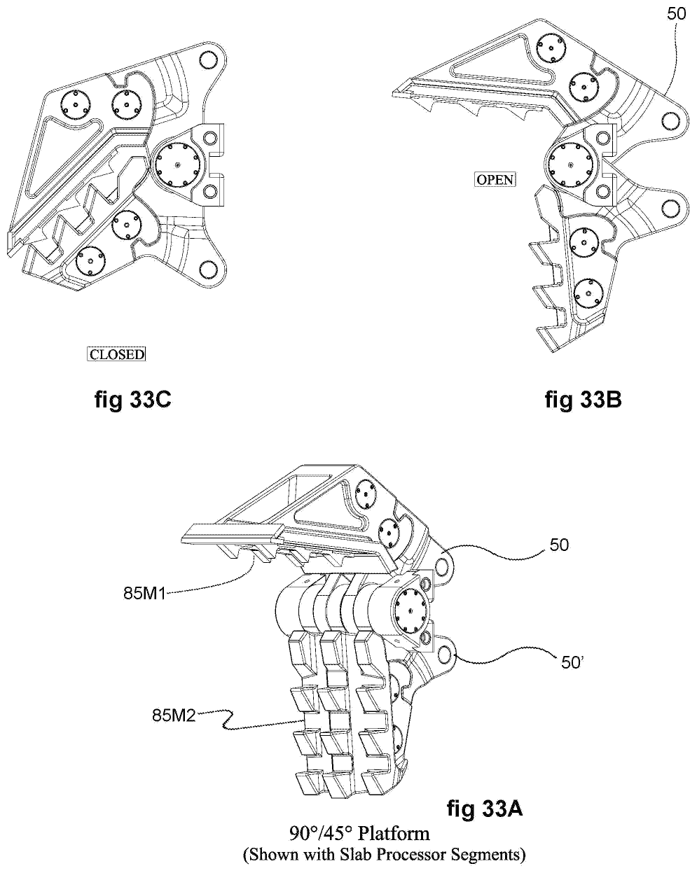

FIGS. 33A-33C are directed to platforms 50, 50′ having segments 85M1 and 85M2 for use as a slab processor.

As a result, the segment 85 of the platform 50 may be dedicated to particular demolition, recycling, or material processing equipment and may be comprised of a concrete crasher, a concrete cracker, a cast breaker or rail breaker, sorting tines, grapple tines, a bucket fabrication, a bucket grab, a tree shear, a slab processor, a heavy melt shear, and slab processor.

The segment 85 may be comprised of any number of working surfaces 90, while the segment 85 has the same cavity 95 for mating with the platform 50. Each different working surface 90 may be configured for a different demolition, recycling, or material processing operation.

It should be appreciated that an individual platform 50 may accommodate a number of different segments 85 as discussed herein. As an example, referring once again to the first jaw 25 of jaw set 20 illustrated in FIGS. 4 and 5, the platform 50 extends away from the rotational axis 40 to define a first side 60, a second side 65 opposite to the first side 60, a first flank 70, and a second flank 75 opposite to the first flank 70, wherein the first side 60 in the second side 65 are between the first flank 70 and the second flank 75. A front end 80 is defined by the ends of the sides 60, 65 and the flanks 70, 75 furthest from the rotational axis 40.

A kit may be provided for a jaw set 20, whereby the first and second jaws 25, 30 of platforms 50, 50′ are capable of accepting a number of different segments 85 to perform a number of different demolition, recycling, or material processing operations. By doing so, as previously mentioned, the segment 85 covers substantially all of the platform 50 surface that would otherwise be exposed to the workpiece. For all practical purposes, the platforms 50, 50′ are protected from the workpiece and do not encounter the wear and tear that they would otherwise experience. Furthermore, the segments 85 may be dedicated to particular operations, such that each segment 85 is optimized for that particular operation. Furthermore, if and when a segment 85 becomes worn or damaged, it is relatively easy to replace the segment 85.

While so far described is a single jaw, the subject invention may also be directed to a jaw set 20 as illustrated in FIGS. 2A-2C and FIG. 3, wherein the jaw set 20 has a first jaw 25 and a second jaw 30. The first jaw 25 is secured through coaxial bores 55 with the pivot pin 35 to the second jaw 30, such that at least one jaw 25, 30 rotates relative to the other jaw 25, 30 about a rotational axis 40. Each jaw 25, 30 is made up of a platform 50. The platform 50 extends away from the rotational axis 40. Each jaw 25, 30 further includes a segment 85 secured to the platform 50, wherein the segment 85 has working surfaces 90 for engaging a workpiece. Furthermore, each segment 85 has a cavity 95 (see FIG. 5) with a shape complementary to the platform 50. The segment 85 covers a substantial portion of the platform 50, such that the platform 50 is shielded from substantially all direct engagement with the workpiece.

As illustrated in FIG. 5, the first side 60 of the platform 50 may be substantially flat. As a result, the inner wall 145 of the segment 85 may also be substantially flat and complementary to the first side 60 of the platform 50.

To illustrate the versatility of such an arrangement, it should be appreciated that the platform 50 illustrated in FIGS. 30A-30C may have segments 85J1 and 85J2 to operate as a grab as illustrated in FIGS. 29A-29C. The very same platform 50, illustrated in FIGS. 31A-31C may accept segments 85K1 and 85K2 to operate as a tree shear. The variation may be as diverse as those shown in FIGS. 22A-22C through 33A-33C. As one example, cracker segments (FIGS. 22A-2C) may be replaced with grapple segments in FIGS. 27A-27C.

As a result, there is essentially no limitation to the variety of segments that may be attached to platforms in the subject invention.

Directing attention to FIGS. 20A-20B, the first side 60 of one platform 50 forms an angle A of 45° with the neutral axis 17, while the first side 60′ of the platform 50′ forms an angle B of 0° with the neutral axis 17.

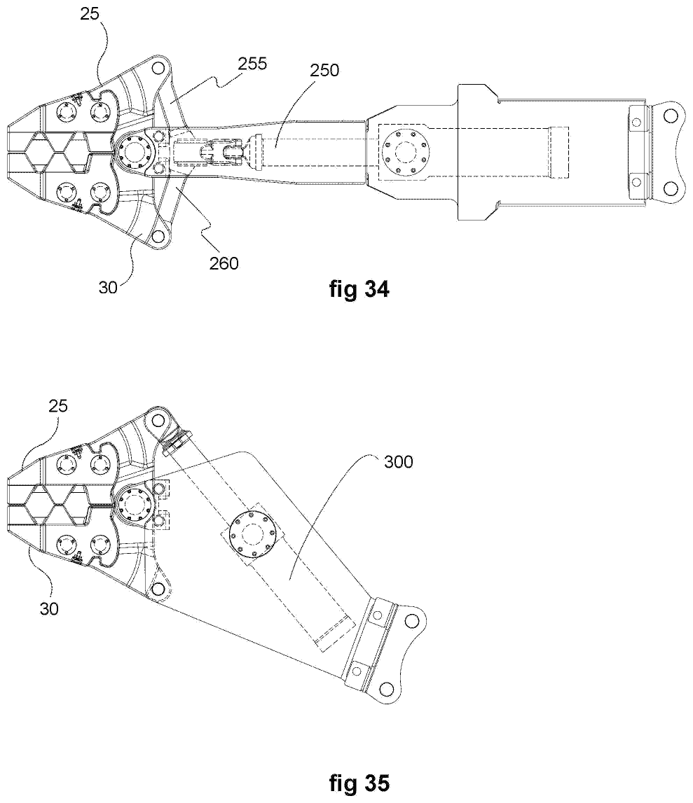

FIG. 34 shows the arrangement similar to that in FIG. 1 wherein a single hydraulic cylinder 250 rotates the two jaws 25, 30, which may be performed using two linkages 255, 260. It is also possible to utilize two separate cylinders wherein each cylinder rotates a jaw 25, 30. In the alternative, as illustrated in FIG. 35, it is possible for a single cylinder 300 to operate only a single jaw 25 while the opposing jaw 30 remains stationary.

It is also possible to have a jaw set 20 wherein the bores 55, 57 through each jaw 25, 30 are spaced apart such that the first jaw 25 and the second jaw 30 are adapted to allow relative rotation between the first jaw 25 and the second jaw 30. Finally, it is possible to have a jaw set 20 wherein one jaw 25 pivots about a bore 55 and the second jaw 30 is fixed but spaced from the first jaw 25 such that there is relative rotation between the jaws 25, 30, although not about a common pivot. In each of these arrangements, the first jaw 25 is secured with a pivot pin 35 and adapted to allow relative rotation between the first jaw 25 and the second jaw 30.

There are multiple advantages provided by the design discussed herein. In the past, there were at least three different protocols when the specific working task of a machine was to change. It was possible to install a dedicated stand-alone tool onto a machine for each particular working task. However, this first required removing the currently mounted tool from the machine before the desired tool could be installed. Removal required not only dismounting the current tool from the boom, but also detaching the linkages and hydraulic hoses of the current tool from the boom. Thereafter, this entire process was repeated in reverse to install the desired tool. This required significant time and resources. Furthermore, this required the user to own/rent multiple dedicated tools which required the capacity to transport these tools.

Another protocol for accommodating different working tasks required of a machine would involve replacing removable dedicated jaws sets. While this was to some extent a more effective manner of addressing the challenge of multiple functions, it required multiple duty specific jaw sets to be used which may be expensive.

Yet another protocol involved utilizing a single jaw set but providing customized inserts or blades on the jaws of the jaw set to accommodate different working tasks. This provided a compromise solution because while a single jaw set may be optimized for a particular working task, when blades or inserts were added to the jaws of the jaw set for other working tasks, the end result was no longer an optimized tool.

Overall, modifying machines or tools to accommodate different working tasks is an expensive, laborious, and time consuming process. By using the segments as described herein, a jaw set can be retained and only the segments attached to the jaws would have to be changed. This results in a more economical and less laborious tool swap that does not hinder optimized tool performance.

Furthermore, with prior designs, the jaw set, including the body of the jaw, would be exposed to the workpiece and, as a result, experience premature wear. Replacement or refurbishment of a jaw or the jaw set is very expensive and time consuming. By using the segments and platforms as described herein, essentially only the segments are exposed to the workpiece. Therefore, most of the time, only the segments would have to be repaired or replaced. As described herein, replacement of the segments is straight forward and may be performed in the field with much greater efficiency than that required to replace an entire jaw set.

Furthermore still, the cost of the segments is significantly less than the cost of a jaw or a jaw set so the cost to use the tool over time is greatly reduced.

As a result, the ability to modify a machine to perform any number of different working tasks is made much easier, is significantly less expensive, takes less time, and may be performed in the field in a relatively straight forward manner, when compared to replacing or servicing a dedicated tool or an entire jaw set.

The present embodiments are merely intended to be illustrative of the present invention and not restrictive thereof. It would be apparent to those of ordinary skill in the art that various modifications may be made to the present invention without departing from the spirit and scope thereof.

1. A jaw of a jaw set for demolition, recycling, or material processing equipment, wherein the jaw is configured to be secured with a pivot pin and adapted to allow rotation of the jaw; the jaw comprising:
a) a platform with a bore to accept the pivot pin extending therethrough about the rotational axis, wherein the platform extends away from the rotational axis to define a first side, a second side opposite to the first side, a first flank and a second flank opposite to the first flank, wherein the first side and second side are between the first flank and second flank, and a front end defined by ends of the sides and flanks furthest from the rotational axis;
b) a segment secured to the platform, wherein the segment has working surfaces for engaging a workpiece and wherein the segment has a cavity with a shape complimentary to the platform which receives the first flank, the second flank, and at least a portion of the first side of the platform, wherein only the segment is adapted to be in direct engagement with the workpiece.

2. The jaw according to claim 1, wherein the segment protrudes beyond the front end of the platform.

3. The jaw according to claim 1, wherein the platform has a platform first bore and the segment has a segment first bore, wherein with the platform and segment mated, the platform first bore is co-axial with the segment first bore to accept a first locking pin.

4. The jaw according to claim 3, wherein the segment is configured to pivot about the first locking pin to engage with the platform.

5. The jaw according to claim 3, wherein the segment has a hook portion and the platform has a complimentary hook portion, which are engaged with one another when the segment pivots to engage with the platform.

6. The jaw according to claim 1, wherein the cavity of the segment has a first wall and an opposing second wall, and also has a front wall and an inner wall therebetween, connecting the first wall to the second wall.

7. The jaw according to claim 1, wherein a fit between the pivot pin and the bore of the jaw is a slip fit.

8. The jaw according to claim 1, wherein the first wall and the second wall of the segment have opposing recesses and an alignment bar is secured to the platform, wherein the alignment bar engages the opposing recesses to limit motion between the platform and the segment.

9. The jaw according to claim 8, wherein the tolerances for the engagement of the alignment bar between the platform and the segment are less than those between the platform and segment such that the alignment bar provides tighter tolerances to secure and align the segment relative to the platform.

10. The jaw according to claim 8, wherein the alignment bar retains the segment to the platform when the first and second locking pins are removed.

11. The jaw according to claim 1, wherein the segment is dedicated to a particular demolition, recycling, or material processing operation and is comprised of a dedicated tool part from the group comprised of a concrete crusher, a concrete cracker, a cast breaker, a rail breaker, sorting tines, grapple tines, a bucket fabrication, a bucket grab, a tree shear, a slab processor, a heavy melt segment shear, and a heavy melt shear.

12. The jaw according to claim 11, wherein the segment may be comprised of any number of different types of working surfaces, while the segment has the same cavity for mating with the platform, wherein each different working surface is configured for a different demolition, recycling, or material processing operation.

13. The jaw according to claim 1, wherein the segment is a single part.

14. The jaw according to claim 1, wherein the segment is at least two parts.

15. A kit for a jaw of a jaw set with interchangeable segments for demolition, recycling, or material processing equipment, wherein the jaw is configured to be secured with a pivot pin and adapted to allow rotation between the jaw and a second jaw; the jaw comprising:
a) a platform with a bore to accept the pivot pin extending therethrough about the rotational axis, wherein the platform extends away from the rotational axis to define a first side, a second side opposite to the first side, a first flank, and a second flank opposite to the first flank, wherein the first side and the second side are between the first flank and second flank, and a front end defined by ends of the sides and flanks furthest from the rotational axis;
b) a first segment adapted to be secured to the platform, wherein the first segment has working surfaces for engaging a workpiece fully dedicated to a first particular task related to demolition, recycling, or material processing and wherein the first segment has a cavity with a shape complimentary to the platform which receives the first flank, the second flank, the first side of the platform, and the front end of the platform, such that the platform is shielded from substantially all direct engagement with the workpiece;
c) a second segment adapted to be secured to the platform, wherein the second segment has working surfaces for engaging a workpiece fully dedicated to a second particular task related to demolition, recycling, or material processing, wherein the first task and the second task are different, and wherein the second segment has a cavity which receives the first flank, the second flank, the first side of the platform, and the front end of the platform, such that the platform is shielded from substantially all direct engagement with the workpiece.

16. The kit according to claim 15, wherein the first segment has working surfaces of a concrete cracker and the second segment has working surfaces of a concrete crusher.

17. The kit according to claim 15, wherein the first segment has working surfaces of a grab and the second segment has working surfaces of a bucket.

18. A jaw set for demolition, recycling, or material processing equipment, wherein the jaw set has a first jaw and a second jaw, wherein the first jaw is configured to be secured with a pivot pin and adapted to allow relative rotation between the first jaw and the second jaw; wherein each jaw comprises:
a) a platform on each jaw, wherein the platform has a bores to accept a pivot pin and extends away from the rotational axis;
b) a segment secured to the platform, wherein the segment has working surfaces for engaging a workpiece and wherein the segment has a cavity with a shape complimentary to the platform, which covers at least 90% of a top surface of the platform extending from the rotational axis to a front end of the platform, such that the platform is shielded from all direct engagement with the workpiece.

19. The jaw set according to claim 18, wherein there is a slip fit between the pivot pin and the bores of the first jaw and the second jaw.

20. The jaw set according to claim 18, wherein the bores of the first jaw and the second jaw are co-axial and the first jaw has two legs spaced from one another with the co-axial bore extending through each leg and wherein the second jaw has three legs spaced from one another with the co-axial bore extending through each, wherein the three spaced apart legs define two slots therebetween and the two legs of the first jaw fit within the slots and are secured by the pivot pin.

21. The jaw set according to claim 20, wherein the distance between the outer edges of the two legs of the first jaw is at least ½ the distance between the outer edges of the three legs of the second jaw.

22. The jaw set according to claim 18, wherein for each platform, the platform extends from the rotational axis to define a first side, a second side opposite to the first side, a first flank, and a second flank opposite to the first flank, wherein the first and second flanks are between the first side and second side, and a front end defined by ends of the sides and flanks furthest from the rotational axis, and wherein the first side of the platform is flat.

23. The jaw set according to claim 22, wherein between the fully open position of the jaw set and the fully closed position of the jaw set, the first sides of each platform of each jaw form an angle of between 0 degrees and 180 degrees with one another.

24. The jaw set according to claim 22, wherein in the fully closed position of the jaw set, the first side platforms of each jaw form an angle of 0 degrees with one another.

25. The jaw set according to claim 22, wherein in the fully closed position of the jaw set, the first side platforms of each jaw form an angle of 45 degrees with one another.

26. The jaw set according to claim 18, wherein the jaw set is attached to a base member and a neutral axis is defined by a line extending through the base member and the co-axial bore of each jaw, and wherein the first side of one platform forms a first angle with the neutral axis and the first side of the other platform forms a second angle with the neutral axis, wherein the first angle and the second angle are different from one another.

27. The jaw set according to claim 26, wherein the jaw set is attached to a base member and a neutral axis is defined by a line extending through the boom and the co-axial bore of each jaw, and wherein the first side of one platform forms an angle of 45 degrees with the neutral axis, and the first side of the other platform forms an angle of 0 degrees with the neutral axis.

28. The jaw set according to claim 18, wherein the engaging portions of each platform have equal widths.

29. A method for securing a platform onto the jaw according to claim 4, comprising the steps of:
a) positioning the segment in a stationary position with the cavity exposed;
b) moving the platform into the cavity so that the platform first bore aligns with the segment first bore;
c) securing the first locking pin into the platform first bore and the segment first bore;
d) pivoting the platform about the first locking pin until a second bore of the segment aligns with a second bore of the platform; and
e) inserting and securing therein a second locking pin into the second bore of the segment and a second bore of the platform.

30. The jaw according to claim 1, wherein the segment is configured as a base upon which customized tools are mounted.

31. A jaw of a jaw set for demolition, recycling, or material processing equipment, wherein the jaw is configured to be secured with a pivot pin and adapted to allow rotation of the jaw; the jaw comprising:
a) a platform with a bore to accept the pivot pin extending therethrough about the rotational axis, wherein the platform extends away from the rotational axis to define a first side, a second side opposite to the first side, a first flank and a second flank opposite to the first flank, wherein the first side and second side are between the first flank and second flank, and a front end defined by ends of the sides and flanks furthest from the rotational axis;
b) a segment secured to the platform, wherein the segment has working surfaces for engaging a workpiece and wherein the segment has a cavity with a shape complimentary to the platform which receives the first flank, the second flank, at least a portion of the first side of the platform, and at least a portion of the front end of the platform such that the platform is shielded from all direct engagement with the work piece.
